(19) United States
(12) Patent Application Publication
(10) Pub. No.: US 2025/0106786 A1
(43) Pub. Date: Mar. 27, 2025

(54) METHOD AND SYSTEM FOR PER BEAM BASED UPLINK DUTY CYCLE MANAGEMENT ACCORDING TO AN EVENT FROM A BODY PROXIMITY SENSOR (BPS)

(71) Applicant: Apple Inc., Cupertino, CA (US)

(72) Inventors: Huaning NIU, San Jose, CA (US); Dawei ZHANG, Saratoga, CA (US); Jie CUI, San Jose, CA (US); Manasa RAGHAVAN, Sunnyvale, CA (US); Qiming LI, Beijing (CN); Xiang CHEN, Campbell, CA (US); Yang TANG, San Jose, CA (US); Yushu ZHANG, Beijing (CN)

(21) Appl. No.: 18/725,063

(22) PCT Filed: Jan. 5, 2022
(86) PCT No.: PCT/CN2022/070301

§ 371 Date: Jun. 27, 2024

(51) Int. Cl. H04W 52/36; H04W 52/28

(52) U.S. Cl. CPC H04W 52/367; H04W 52/283

(57) ABSTRACT

A user equipment including a transceiver and a processor is configured to receive, from a base station and via the transceiver, a set of resource indicators identifying a set of beams and a configuration for reporting a duty cycle for transmission in an uplink direction for at least one resource indicator of the set of resource indicators. The processor is also configured to, at least one of periodically or based on an event reported by a body proximity sensor (BPS), determine the duty cycle for transmission in the uplink direction for the at least one resource indicator of the set of resource indicators; and transmit, to the base station via using the transceiver, the determined duty cycle and the corresponding at least one resource indicator of the set of resource indicators according to the received configuration for reporting the duty cycle.

### CROSS-REFERENCE TO RELATED APPLICATION

This application is a 35 U.S.C. § 371 application of PCT/CN2022/070301, filed on Jan. 5, 2022, and entitled “Method and System for Per Beam Based Uplink Duty Cycle Management According to an Event from a Body Proximity Sensor (BPS),” which is incorporated herein by reference as if fully disclosed herein.

### TECHNICAL FIELD

Embodiments described herein generally relate to a method and system for per beam based uplink duty cycle management by a user equipment (UE), in accordance with a human presence determined by a body proximity sensor of the UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 depicts an example environment in which embodiments described herein may be practiced.

FIG. 2 depicts an example scenario of an uplink duty cycle for one or more beams of a set of beams, in accordance with some embodiments.

FIG. 3 depicts another example scenario of an uplink duty cycle for one or more beams of a set of beams, in accordance with some embodiments.

FIG. 4 depicts another example scenario of an uplink duty cycle for one or more beams of a set of beams, in accordance with some embodiments.

FIG. 5 depicts an example flow chart for reporting an uplink duty cycle from a UE perspective, in accordance with some embodiments.

FIG. 6 depicts an example flow chart for a beam selection process from the base station perspective, in accordance with some embodiments.

FIG. 7 depicts an example flow chart describing operations of a beam selection process, in accordance with some embodiments.

FIG. 8 depicts an example architecture of a wireless communication system of a cellular carrier domain, according to embodiments disclosed herein.

FIG. 9 depicts a system for performing signaling between a UE and a network device, according to embodiments disclosed herein.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, modifications, and equivalents as can be included within the spirit and scope of the described embodiments as defined by the appended claims.

Embodiments described herein include methods and apparatuses (e.g., a user equipment (UE), a base station, and so on) for per beam based duty cycle management. In particular, various embodiments described herein are related to per beam based duty cycle management based on an event including but not limited to detecting presence or absence of a human being near the UE using a body proximity sensor (BPS) of the UE.

Data between a user equipment (UE) and a base station (e.g., a NB, an eNB, an eNodeB, and so on) may be transmitted in an uplink and/or a downlink direction using one or more beams selected using a beam selection procedure. Transmit power at which the UE can transmit data to the base station in the uplink direction over a beam may be limited. In some cases, transmit power for a beam may be controlled by managing an uplink duty cycle for the beam by the UE. Duty cycle defines a portion or a fraction of a cycle during which data may be transmitted. Thus, higher duty cycle may improve data throughput, and may also need higher transmit power.

However, to limit radiation exposure to a human being when a human being is detected within a threshold distance of a UE, the transmit power for one or more beams may be required to be reduced or increased to meet maximum power emission criteria set for the UE. The transmit power may thus be managed on a per beam basis. The transmit power may be managed by increasing and/or decreasing the duty cycle for one or more beams.

As described herein, a body proximity sensor in a UE may determine the presence or absence of a human being near the UE. The UE may be configured to determine, based on the absence or presence of a human being, one or more beams that may be required to update their transmit power, i.e., increase or decrease transmit power for one or more beams.

Generally, the UE transmits data in the uplink direction over a beam that is selected by the base station for transmission of data in the downlink direction by the base station. Accordingly, if the base station selects a beam for transmission of data in the downlink direction, for which the UE needs to reduce transmit power, for example, by reducing duty cycle for a beam, to reduce radiation exposure to a human being within a threshold distance from the UE, data throughput between the UE and the base station will be reduced.

In addition, the UE may be configured to transmit data in the uplink direction at a specific transmit power and/or a specific duty cycle only to reduce radiation exposure to a human being. However, when no human being is detected within a threshold distance from the UE, still transmitting data at the transmit power that is limited to reduce radiation exposure and/or at a duty cycle that limits transmit power, will also reduce data throughput between the UE and the base station.

In other words, duty cycle management may be improved by detecting the presence or absence of a human being using a BPS of a UE. For example, when a UE detects, using a BPS, that a human being is within a threshold distance from the UE that warrants the UE to reduce transmit power for one or more beams, the UE may reduce the uplink duty cycle for one or more beams. The UE may report the uplink duty cycle for one or more beams to the base station. The uplink duty cycles may be reported in a media access control (MAC) layer control element (MAC CE). And, when a UE detects using a BPS that no human being is within a threshold distance from the UE, the UE may increase the duty cycle for one or more beams for uplink data transmission, thereby increasing data throughput and network efficiency.

A base station may perform a beam selection process based on the received duty cycle report for one or more beams, in addition to other measurement reports, including one or more P-MPR and/or L1-RSRP reports.

In some cases, the UE may determine that a human being has moved away from the UE and/or one or more beams by a threshold distance, and transmit power for one or more beams may thus be increased. The UE may accordingly recalculate the duty cycle for one or more beams to increase transmit power for uplink data transmission, thereby improving data throughput and network efficiency.

In some cases, the transmit power for a beam may be required to be reduced for one or more reasons, for example, including but not limited to, presence of a human being within a threshold distance from the UE and/or one or more beams for data transmission, link condition, data buffer status for the uplink data transmission, a UE specific effective and isotropically radiated power (EIRP), and so on.

As described herein in accordance with some embodiments, a beam may be selected based on the uplink duty cycle reported by a UE, in addition to other measurement reports from the UE. The UE may report a duty cycle corresponding to at least one beam that is identified based on a synchronization signal block (SSB) resource indicator (SSBRI), or a channel state information reference signal (CSI-RS) resource indicator (CRI).

The base station may transmit beam configuration information identifying one or more beams for data transmission in the uplink and/or downlink direction using a set of resource indicators. The set of resource indicators may include one or more SSBRIs and/or CRIs. The UE may perform measurements for the uplink duty cycle in addition to P-MPR measurements and L1-RSRP measurements for each beam, and may generate one or more reports for the uplink duty cycle in addition to a P-MPR report and/or a L1-RSRP report, each including corresponding one or more resource indicators (e.g., SSBRIs and/or CRIs, and so on) associated with one or more beams. The base station may consume the received reports for the uplink duty cycle, P-MPR reports, and L1-RSRP reports for a beam selection process.

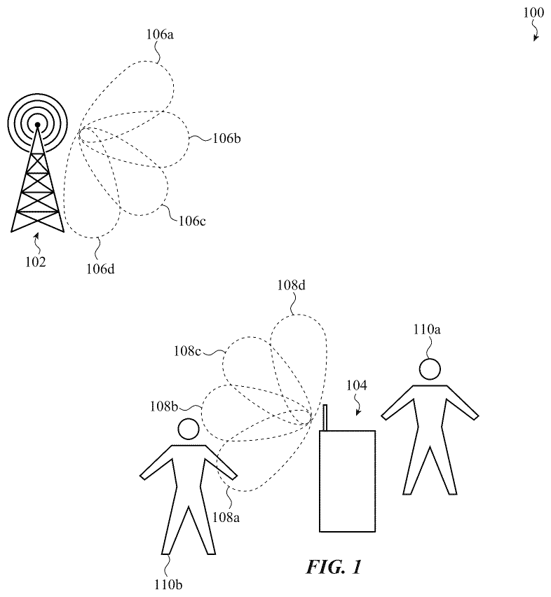

FIG. 1 depicts an example environment in which embodiments described herein may be practiced. As shown in FIG. 1, a network 100 may include a base station 102 and a UE 104. Data may be transmitted between the UE 104 and the base station 102 using one or more beams, for example, beams 106a, 106b, 106c, and/or 106d of the base station 102 and beams 108a, 108b, 108c, and/or 108d of the UE 104. As stated above, each beam may be identified by a resource indicator. The set of resource indicators may include one or more SSBRIs and/or one or more CRIs. An SSBRI and/or a CRI identifies a beam for data transmission in the uplink and/or downlink direction. For example, in an idle mode during an initial access procedure, a beam may be identified using an SSBRI, and in a connected mode, a beam may be identified using a CRI.

The base station 102 may send to the UE 104 a list of resource indicators (e.g., SSBRIs and/or CRIs) identifying a group or a set of one or more beams. By way of a non-limiting example, the list of resource indicators (including the SSBRIs and/or the CRIs) for reporting an uplink duty cycle for one or more beams identified by one or more resource indicators (e.g., SSBRIs and/or CRIs) may be sent using one or more MAC CEs. In some cases, the list of resource indicators may be preconfigured or statically configured. In some cases, the list of resource indicators may be dynamically configured based on transmission configuration indicator (TCI) state values, and/or one or more downlink reference signals (DL RSs).

In some cases, the base station 102 may include the list of the P-MPR report and the L1-RSRP report may include different resource indicators. However, there may be at least one resource indicator common between the list of resource indicators for the P-MPR report the L1-RSRP report. In some embodiments, the list of resource indicators for the P-MPR report and the L1-RSRP report may be the same. In some cases, the list of resource indicators for the P-MPR report may be a subset of the list of resource indicators for the L1-RSRP report.

The base station 102 may also send configuration information to the UE 104 for sending the uplink duty cycle to the base station 102. By way of a non-limiting example, the configuration information may be transmitted using a radio resource control configuration (RRCConfiguration) message, and may indicate to send an uplink duty cycle report periodically, and/or aperiodically (e.g., upon an event, including but not limited to, in which the P-MPR meets a specific criterion (e.g., when per-beam P-MPR change and/or uplink duty cycle change exceeds a specific threshold), when P-MPR change and/or uplink duty cycle change occurs for a specific number of beams, and/or when P-MPR and/or uplink duty cycle change occurs for a beam currently used for data transmission in the uplink and/or downlink direction, and/or when there is an uplink resource for physical uplink shared channel (PUSCH) transmission, and so on). In some cases, the configuration information may indicate that the UE send an uplink duty cycle report for a resource indicator for which the P-MPR value is zero, in other words, no transmit power reduction is required for a beam. In some cases, the configuration information may indicate that the UE 104 may send the uplink duty cycle report independently or asynchronously of other measurement reports, for example, a P-MPR report, and/or an L1-RSRP report.

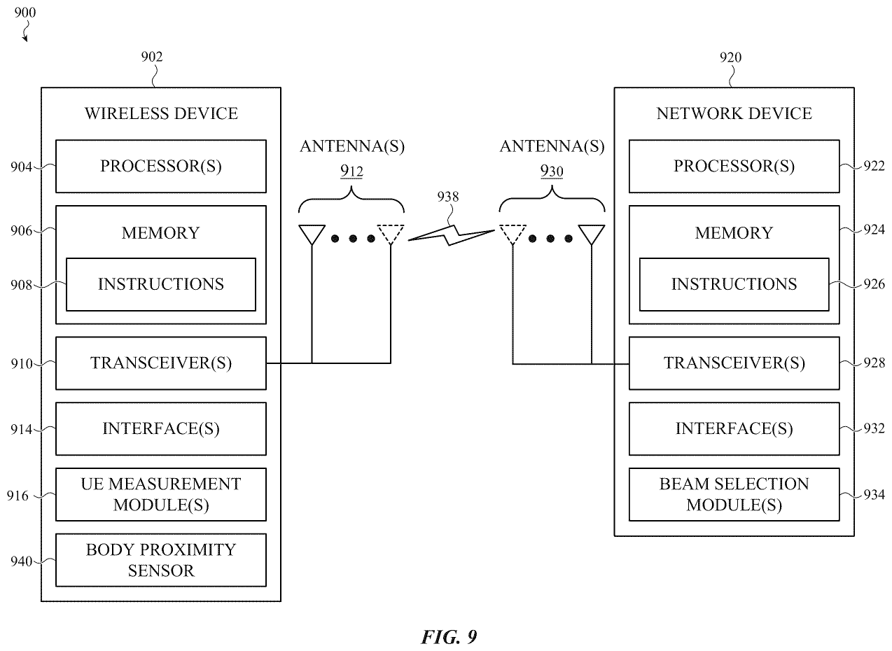

The UE may include a BPS (shown in FIG. 9) which may be configured to detect presence and/or absence of a human being. When the UE detects presence of a human being within a threshold distance of the UE, the UE may determine one or more beams of the beams 108a, 108b, 108c, and/or 108d that may require their transmit power to be reduced. The transmit power is reduced when a human being is detected within a threshold distance of the UE for reducing radiation exposure to a human being and to meet the maximum power emission requirement as set for the UE in the presence of a human being. By way of a non-limiting example, the transmit power for a beam may be reduced by reducing the uplink duty cycle, and the UE may report the updated duty cycle for one or more beams to the base station.

Accordingly, when a user is at a position 110a, the BPS may determine that the user is not within a threshold distance of the UE 104, and, therefore, the UE may transmit data using one or more beams of the beams 108a, 108b, 108c, and/or 108d at a higher transmit power. As well, the UE may determine that an uplink duty cycle for one or more beams may be increased in order to increase transmit power for the one or more beams. The UE may send to the base station an uplink duty cycle report which may indicate an increase in the uplink duty cycle.

But when the BPS detects the user is now at a position 110b, which is within a threshold distance of the UE and/or one or more beams of the beams 108a, 108b, 108c, and/or 108d, the UE may reduce transmit power for the one or more beams of the beams 108a, 108b, 108c, and/or 108d. The UE 104 may send an uplink duty cycle report in which an uplink duty cycle for one or more beams may be reduced to reduce transmit power for one or more beams to meet the maximum power emission criteria.

In some embodiments, the UE 104 may send the uplink duty cycle report to the base station 102 in a new media access control layer control element (MAC CE). By way of a non-limiting example, in one MAC CE, the UE may send an uplink duty cycle and corresponding at least one resource indicator. For example, the UE may send an uplink duty cycle report in which one MAC CE may include four resource indicators and corresponding uplink duty cycle information. In some cases, the UE 104 may send the uplink duty cycle report in uplink control information in a physical uplink control channel (PUCCH) and/or a physical uplink shared channel (PUSCH) message.

As stated above, a beam may be identified or associated with a resource indicator. The base station 102 may associate the received uplink duty cycle report and other UE measurement reports for a beam selection for data transmission in an uplink and/or a downlink direction.

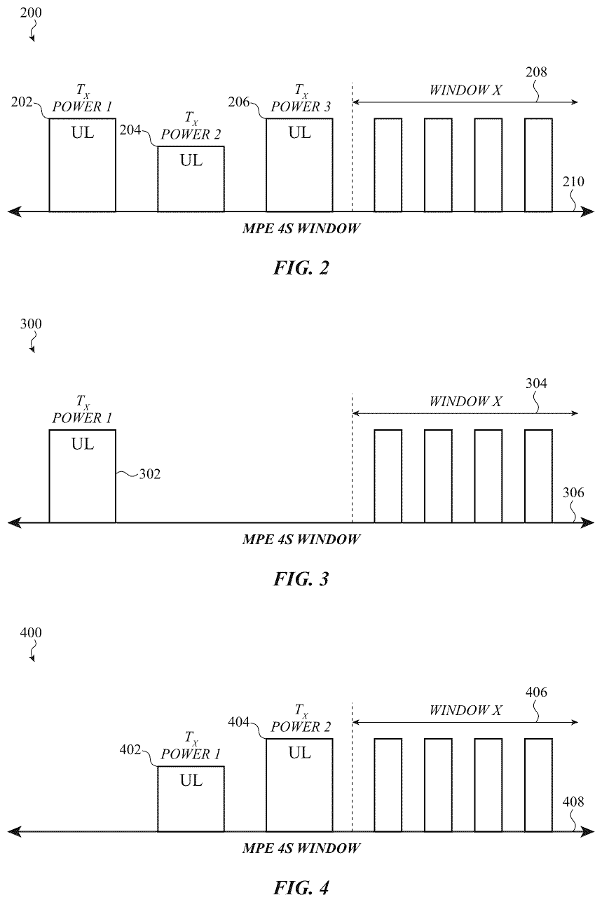

FIG. 2 depicts an example scenario of an uplink duty cycle for one or more beams of a set of beams, in accordance with some embodiments. As shown in FIG. 2, a chart 200 may illustrate uplink duty cycles for a beam for a maximum power emission (MPE) window 210. By way of a non-limiting example, the maximum power emission window 210 may be of four seconds. The UE 104 may determine, and update transmit power for data transmission in an uplink direction for a part of the MPE window 210. For example, the UE 104 may transmit data in the uplink direction at transmit power 1 202, transmit power 2 204, and transmit power 3 206 for a part of the MPE window 210. The transmit power 1 202, transmit power 2 204, and transmit power 3 206 may have been reduced, for example, to meet MPE criteria based on detection of a human being using a body proximity sensor of the UE 104.

However, the UE may determine that a human being is not within a threshold distance of the UE, and accordingly there is no need to reduce transmit power for the remaining part of the MPE window 210. The UE may increase the uplink duty cycle for the remaining part of the MPE window 210, shown in FIG. 2 as window X 208, during which transmit power is not reduced, or P-MPR value is zero. In other words, the UE may increase the uplink duty cycle for the remaining part of the MPE window 210 according to a configured value for a UE specific effective and isotropically radiated power (EIRP) specification. In some cases, the UE may determine that there is a human being within a threshold distance of the UE, the UE may calculate the maximum uplink duty cycle within the window X 208 to ensure that the total transmit power within the MPE window 210 meets the regulation requirement by taking into account of previous transmission power 202, 204, and 206 within the MPE window 210.

In some cases, the window X 208 may be provided to the UE 104 as a configuration parameter for which the UE 104 needs to measure and/or report an updated duty cycle information in an uplink duty cycle report. In some cases, the configuration parameter for which the UE 104 needs to measure and/or report an updated duty cycle information in an uplink duty cycle report may be provided using radio resource control (RRC) signaling. In some cases, a value of the window X 208 may be set to 1. When the value of the window X 208 is set to 1, the UE may calculate and/or update an uplink duty cycle for a 1 second duration of the MPE window 210 based on transmission in the uplink duration during the previous 3 seconds.

In some cases, a value of the window X 208 may be set to indicate the UE 104 may need to calculate and/or update an uplink duty cycle for a next prohibit timer window. When the UE has sent an uplink duty cycle report to the base station, the UE may be restricted to send another uplink duty cycle report for a specific time duration, which is referenced herein as a prohibit timer window. Accordingly, the UE may determine whether an uplink duty cycle may be adjusted based on absence or presence of a human being detected using a BPS of a UE. The UE may calculate and/or adjust an uplink duty cycle for the next prohibit timer duration according to a configured value for UE specific EIRP specification.

In some cases, the UE 104 may receive configuration information for the prohibit timer for uplink duty cycle (ProhibitTimerULdutyCycle) and/or an uplink duty cycle change threshold value (ULDutyCycleChangeThreshold) from the base station 102 via a radio resource control configuration (RRCConfiguration) message. The base station 102 may be configured and/or instructed to send the ProhibitTimerULdutyCycle and/or ULDutyCycleChangeThreshold information from a core network.

In some embodiments, a value of the window X 208 may be set to indicate the UE 104 may need to calculate and/or update an uplink duty cycle periodically, at every preconfigured time duration. The UE may therefore report an uplink duty cycle calculated and/or adjusted for the next periodic interval, as described herein.

In some embodiments, the chart 200 may illustrate uplink transmission for a beam group including a beam 1 transmitting at transmit power 1 202, a beam 2 transmitting at transmit power 2 204, and a beam 3 transmitting at transmit power 3 206. The UE 104 may determine that for the beam group including the beam 1, beam 2, and beam 3, the transmit power is not required to be reduced because a BPS of the UE 104 does not indicate presence of a human being within a threshold distance of the UE. Accordingly, the UE may transmit data in the uplink direction at the maximum transmit power without limiting an uplink duty cycle for the beam group. In other words, the UE may determine for the beam group that P-MPR value can be zero and the uplink duty cycle may be increased or adjusted according to a configured value for UE specific EIRP specification.

In some cases, the beam 1, the beam 2, and the beam 3 of the beam group may be non-overlapping. In such cases, the UE may determine an adjusted duty cycle for one or more beams of the beam 1, the beam 2, and the beam 3 and report in the uplink duty cycle report to the base station.

In some cases, the UE may report the uplink duty cycle for more than one duty cycle period. For example, the UE may report the uplink duty cycle for two duty cycle periods. In some cases, for the non-overlapping beams of a beam group, the UE may send separate uplink duty cycle reports for each beam. However, in some cases, the UE may send an uplink duty cycle report for more than one beam of a beam group, each identified by its corresponding resource indicator.

In some cases, the beam 1, the beam 2, and the beam 3 of the beam group may be overlapping with each other. In such cases, the UE may determine an adjusted duty cycle for one or more beams of the beam 1, the beam 2, and the beam 3 based on an average of the transmit power of the overlapping beam 1, beam 2, and beam 3, and report in an uplink duty cycle report to the base station identifying corresponding resource indicators.

In some embodiments, the chart 200 may illustrate uplink transmission for a beam group 1 including a beam 1 transmitting at transmit power 1 202, and a beam group 2 including a beam 2 transmitting at transmit power 2 204 and a beam 3 transmitting at transmit power 3 206. In this case, the UE may determine the uplink duty cycle for each beam group separately, as described below using FIG. 3 and FIG. 4.

FIG. 3 depicts another example scenario of the uplink duty cycle for one or more beams of a set of beams, in accordance with some embodiments. As shown in FIG. 3, a chart 300 may illustrate uplink duty cycles for a beam for a maximum power emission (MPE) window 306. By way of a non-limiting example, the maximum power emission window 306, as described above, may be of four seconds. The UE 104 may determine, and update transmit power for data transmission in an uplink direction for a part of the MPE window 306, for example a window X 304. For example, the UE 104 may transmit data in the uplink direction at transmit power 1 302, some part of the MPE window 306. The transmit power 1 302 may have been reduced, for example, to meet MPE criteria based on detection of a human being using a body proximity sensor of the UE 104.

However, the UE may determine that a human being is not within a threshold distance of the UE, and accordingly there is no need to reduce transmit power for the remaining part of the MPE window 306. The UE may increase the uplink duty cycle for the remaining part of the MPE window 306, shown in FIG. 3 as window X 304, during which transmit power is not reduced, or a P-MPR value is zero. In other words, the UE may increase the uplink duty cycle for the remaining part of the MPE window 306 according to a configured value for a UE specific EIRP specification. In some cases, the UE may determine that there is a human being within a threshold distance of the UE, the UE may calculate the maximum uplink duty cycle within the window X 304 to ensure that the total transmit power within the MPE window 306 meets the regulation requirement by taking into account of previous transmission power 302 within the MPE window 306. In other words, FIG. 3 illustrates the UE may determine, calculate, and/or adjust an uplink duty cycle for each beam group separately and/or for each beam of a beam group separately.

FIG. 4 depicts another example scenario of an uplink duty cycle for one or more beams of a set of beams, in accordance with some embodiments. As shown in FIG. 4, a chart 400 may illustrate uplink duty cycles for a beam for a maximum power emission (MPE) window 408. By way of a non-limiting example, the maximum power emission window 408 may be of four seconds. The UE 104 may determine, and update transmit power for data transmission in an uplink direction for a part of the MPE window 408. For example, the UE 104 may transmit data in the uplink direction at transmit power 1 402, and transmit power 2 404 for a part of the MPE window 408. The transmit power 1 402 and transmit power 2 404 may have been reduced, for example, to meet MPE criteria based on detection of a human being using a body proximity sensor of the UE 104.

However, the UE may determine that a human being is not within a threshold distance of the UE, and accordingly there is no need to reduce transmit power for the remaining part of the MPE window 408. The UE may increase the uplink duty cycle for the remaining part of the MPE window 408, shown in FIG. 4 as window X 406, during which transmit power is not reduced, or the P-MPR value is zero. In some cases, the UE may determine that there is a human being within a threshold distance of the UE for a beam direction group, the UE may calculate the maximum uplink duty cycle within the window X 406, to ensure that the total transmit power within the MPE window 408 meets the regulation requirement by taking into account of previous transmission power 402 and 402 for the beam direction group within the MPE window 408. In other words, the UE may increase the uplink duty cycle for the remaining part of the MPE window 408 according to a configured value for a UE specific EIRP specification.

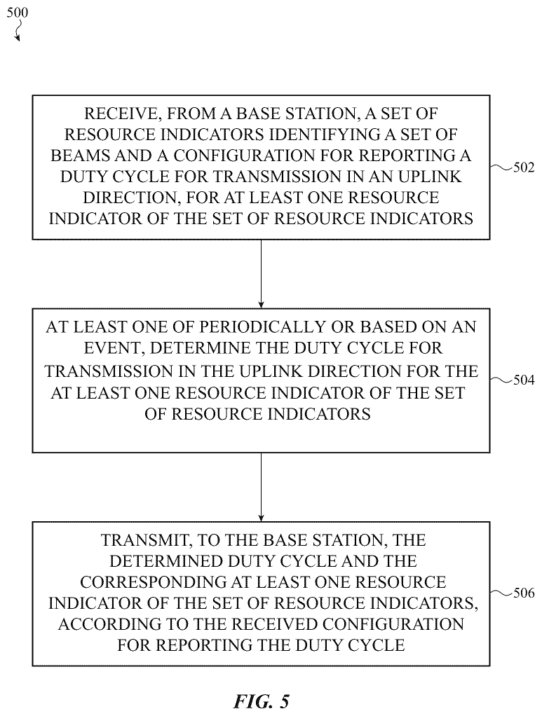

FIG. 5 depicts an example flow chart for reporting an uplink duty cycle from a UE perspective, in accordance with some embodiments. As shown in FIG. 5, a flow chart 500 illustrates operations performed by a UE, for example, the UE 104, as described herein. At 502, the UE 104 may receive from the base station 102 a set of resource indicators and/or a configuration for reporting an uplink duty cycle for one or more beams to the base station 102. Each beam of the one or more beams may be identified by a resource indicator of the set of resource indicators. As described above, the set of resource indicators may include one or more SSBRIs and/or one or more CRIs. Thus, each resource indicator may identify a beam for data transmission in an uplink and/or a downlink direction.

In some cases, a configuration for reporting an uplink duty cycle for one or more beams to the base station 102 may include a configuration parameter for which the UE 104 needs to measure, and/or report an updated duty cycle information in an uplink duty cycle report. In some cases, the configuration parameter for which the UE 104 needs to measure and/or report an updated duty cycle information in an uplink duty cycle report may be provided using radio resource control (RRC) signaling. In some cases, a value of the configuration parameter may be set to, for example, 1, which may indicate the UE 104 to calculate and/or update an uplink duty cycle for 1 second duration of a MPE window. By way of a non-limiting example, the MPE window may be of four seconds. Accordingly, the received value for the configuration parameter may cause the UE to calculate and/or adjust an uplink duty cycle based on transmission in the uplink duration during the previous 3 seconds of the MPE window.

In some cases, a value of the configuration parameter may be set to, a value that indicates the UE 104 may need to calculate and/or update an uplink duty cycle for a next prohibit timer window. When the UE has sent an uplink duty cycle report to the base station, the UE may be restricted to send another uplink duty cycle report for a specific time duration, which is referenced herein as a prohibit timer window. Accordingly, the UE may determine whether an uplink duty cycle may be adjusted based on absence or presence of a human being detected using a BPS of a UE. The UE may calculate and/or adjust an uplink duty cycle for the next prohibit timer duration according to a configured value for a UE specific EIRP specification.

In some embodiments, a value of the configuration parameter may be set to a value that indicates the UE 104 may need to calculate and/or update an uplink duty cycle periodically, at every preconfigured time duration. The UE may therefore report an uplink duty cycle calculated and/or adjusted for the next periodic interval, as described herein.

At 504, the UE 104 may calculate an uplink duty cycle for one or more beams as described herein. The uplink duty cycle for one or more beams may be calculated according to the configuration received from the base station 102. The configuration received at the UE 104 from the base station 102 may indicate that an uplink duty cycle may be determined periodically, and/or based on an event, for example, an event reported from a BPS of the UE 104. A BPS of the UE 104 may detect presence or an absence of a human being near the UE 104. Based on the detection of presence of absence of a human being, the UE 104 may determine that transmit power for one or more beams may be decreased or increased to meet MPE requirements according to a UE specific EIRP specification. The UE 104 may, accordingly, calculate and/or adjust an uplink duty cycle for one or more beams as described herein. As stated above, a beam is identified by its corresponding resource indicator. Thus, the UE 104 may calculate and/or adjust an uplink duty cycle for one or more resource indicators of the set of resource indicators by the UE 104 from the base station 102 at 502 above.

At 506, the UE 104 may transmit to the base station 102, a duty cycle calculated or determined at 504 above for one or more beams with associated one or more resource indicators. The duty cycle report may be transmitted in a MAC CE. As stated above, each MAC CE may include a duty cycle report for one or more resource indicators. In some cases, the duty cycle report for each beam of a beam group and/or different beam groups may be sent separately.

In some cases, the UE 104 may transmit the duty cycle report with or without buffer status reporting (BSR) that informs the base station 102 of data to be transmitted in an uplink direction.

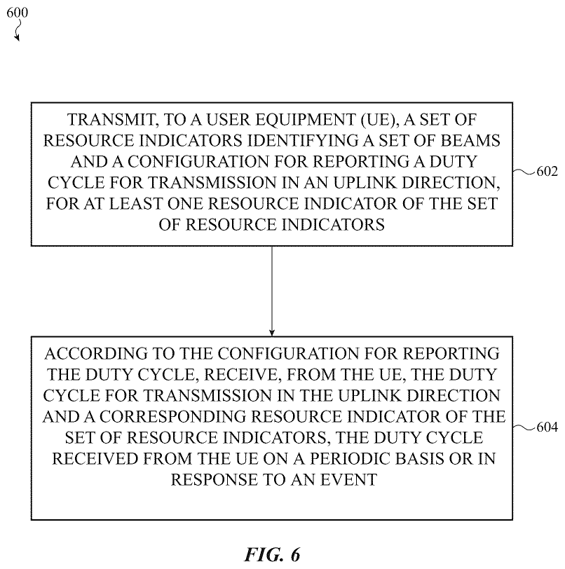

FIG. 6 depicts an example flow chart for reporting an uplink duty cycle from a base station perspective, in accordance with some embodiments. As shown in FIG. 6, a flow chart 600 illustrates operations performed by a base station, for example, the base station 102, as described herein. At 602, the base station 102 may transmit to the UE 104 a set of resource indicators and/or a configuration for reporting an uplink duty cycle for one or more beams to the base station 102. Each beam of the one or more beams may be identified by a resource indicator of the set of resource indicators. As described above, the set of resource indicators may include one or more SSBRIs and/or one or more CRIs. Thus, each resource indicator may identify a beam for data transmission in an uplink and/or a downlink direction.

In some cases, a configuration for reporting an uplink duty cycle for one or more beams to the base station 102 may include a configuration parameter for which the UE 104 needs to measure and/or report an updated duty cycle information in an uplink duty cycle report. In some cases, the configuration parameter for which the UE 104 needs to measure and/or report an updated duty cycle information in an uplink duty cycle report may be provided using radio resource control (RRC) signaling. In some cases, a value of the configuration parameter may be set to, for example, 1, which may indicate the UE 104 to calculate and/or update an uplink duty cycle for a 1 second duration of a MPE window. By way of a non-limiting example, the MPE window may be of four seconds. Accordingly, the received value for the configuration parameter may cause the UE to calculate and/or adjust an uplink duty cycle based on transmission in the uplink duration during the previous 3 seconds of the MPE window.

In some cases, a value of the configuration parameter may be set to a value that indicates the UE 104 may need to calculate and/or update an uplink duty cycle for a next prohibit timer window. When the UE has sent an uplink duty cycle report to the base station, the UE may be restricted to send another uplink duty cycle report for a specific time duration, which is referenced herein as a prohibit timer window. Accordingly, the UE may determine whether an uplink duty cycle may be adjusted based on absence or presence of a human being detected using a BPS of a UE. The UE may calculate and/or adjust an uplink duty cycle for the next prohibit timer duration according to a configured value for UE specific EIRP specification.

In some embodiments, a value of the configuration parameter may be set to a value that indicates the UE 104 may need to calculate and/or update an uplink duty cycle periodically, at every preconfigured time duration. The UE may therefore report an uplink duty cycle calculated and/or adjusted for the next periodic interval, as described herein.

At 604, the base station 102 may receive a duty cycle report that includes one or more duty cycles determined by the UE 104 according to the configuration sent to the UE 104 at 602 above. The one or more duty cycle reports include a determined duty cycle for a one second duration of a MPE window of four seconds, a next prohibit timer duration, and/or for a preconfigured time interval on a periodic basis, and/or based on an event, for example, reported from a BPS of the UE 104, and so on. As mentioned above, an event may include change in an uplink duty cycle that exceeds a specific threshold, change in an uplink duty cycle value for a specific number of beams, and/or change in an uplink duty cycle value that occurs for a beam being used for data transmission in the uplink or a downlink direction.

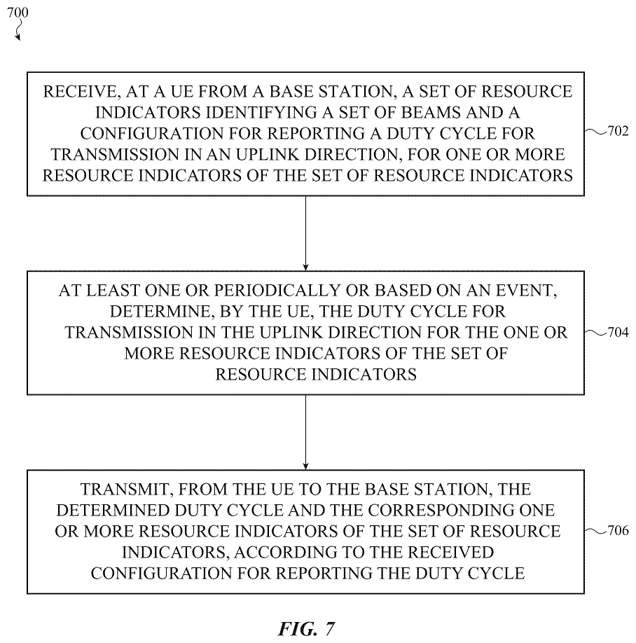

FIG. 7 depicts an example flow chat describing operations for a duty cycle reporting from a UE to a base station, in accordance with some embodiments. As shown in FIG. 7, a flow chart 700 illustrates operations performed for reporting a duty cycle, as described herein. At 702, the UE 104 may receive, from the base station 102 via a transceiver of the UE 104, a set of resource indicators and/or a configuration for reporting an uplink duty cycle for one or more beams to the base station 102. Each beam of the one or more beams may be identified by a resource indicator of the set of resource indicators. As described above, the set of resource indicators may include one or more SSBRIs and/or one or more CRIs. Thus, each resource indicator may identify a beam for data transmission in an uplink and/or a downlink direction.

In some cases, a configuration for reporting an uplink duty cycle for one or more beams to the base station 102 may include a configuration parameter for which the UE 104 needs to measure and/or report an updated duty cycle information in an uplink duty cycle report. In some cases, the configuration parameter for which the UE 104 needs to measure and/or report an updated duty cycle information in an uplink duty cycle report may be provided using radio resource control (RRC) signaling. In some cases, a value of the configuration parameter may be set to, for example, 1, which may indicate the UE 104 to calculate and/or update an uplink duty cycle for a 1 second duration of a MPE window. By way of a non-limiting example, the MPE window may be of four seconds. Accordingly, the received value for the configuration parameter may cause the UE to calculate and/or adjust an uplink duty cycle based on transmission in the uplink duration during the previous 3 seconds of the MPE window.

In some cases, a value of the configuration parameter may be set to, a value that indicates the UE 104 may need to calculate and/or update an uplink duty cycle for a next prohibit timer window. When the UE has sent an uplink duty cycle report to the base station, the UE may be restricted to send another uplink duty cycle report for a specific time duration, which is referenced herein as a prohibit timer window. Accordingly, the UE may determine whether an uplink duty cycle may be adjusted based on absence or presence of a human being detected using a BPS of a UE. The UE may calculate and/or adjust an uplink duty cycle for the next prohibit timer duration according to a configured value for UE specific EIRP specification.

In some embodiments, a value of the configuration parameter may be set to a value that indicates the UE 104 may need to calculate and/or update an uplink duty cycle periodically, at every preconfigured time duration. The UE may therefore report an uplink duty cycle calculated and/or adjusted for the next periodic interval, as described herein.

At 704, the UE 104 may calculate or determine an uplink duty cycle for one or more beams as described herein. The uplink duty cycle for one or more beams may be calculated according to the configuration received from the base station 102. The configuration received at the UE 104 from the base station 102 may indicate that an uplink duty cycle may be determined periodically, and/or based on an event, for example, reported from a BPS of the UE 104. A BPS of the UE 104 may detect presence or an absence of a human being near the UE 104. Based on the detection of presence of absence of a human being, the UE 104 may determine that transmit power for one or more beams may be decreased or increased to meet the MPE requirement according to a UE specific EIRP specification. The UE 104 may, accordingly, calculate and/or adjust an uplink duty cycle for one or more beams as described herein. As stated above, a beam is identified by its corresponding resource indicator. Thus, the UE 104 may calculate and/or adjust an uplink duty cycle for one or more resource indicators of the set of resource indicators by the UE 104 from the base station 102 at 702 above.

At 706, the UE 104 may transmit to the base station 102, a duty cycle calculated or determined at 704 above for one or more beams with associated one or more resource indicators. The duty cycle report may be transmitted in a MAC CE. As stated above, each MAC CE may include a duty cycle report for one or more resource indicators. In some cases, the duty cycle report for each beam of a beam group and/or different beam groups may be sent separately.

In some cases, the UE 104 may transmit the duty cycle report with or without buffer status reporting (BSR) that informs the base station 102 of data to be transmitted in an uplink direction.

Embodiments contemplated herein include an apparatus having means to perform one or more elements of the method 500, 600, or 700. In the context of method 500, or 700, this apparatus may be, for example, an apparatus of a UE (such as a wireless device 902 that is a UE, as described herein). In the context of method 600, or 700, this apparatus may be, for example, an apparatus of an access point or a base station (such as a network device 918 that is an access point or a base station, as described herein).

Embodiments contemplated herein include one or more non-transitory computer-readable media storing instructions to cause an electronic device, upon execution of the instructions by one or more processors of the electronic device, to perform one or more elements of the method 500, 600, or 700. In the context of method 500, or 700, this non-transitory computer-readable media may be, for example, a memory of a UE (such as a memory 906 of a wireless device 902 that is a UE, as described herein). In the context of method 600, or 700, this non-transitory computer-readable media may be, for example, a memory of an access point or a base station (such as a memory 924 of a network device 918 that is an access point or a base station, as described herein).

Embodiments contemplated herein include an apparatus having logic, modules, or circuitry to perform one or more elements of the method 500, 600, or 700. In the context of method 500, or 600, this apparatus may be, for example, an apparatus of a UE (such as a wireless device 902 that is a UE, as described herein). In the context of method 600, or 700, this apparatus may be, for example, an apparatus of an access point or a base station (such as a network device 918 that is an access point or a base station, as described herein).

Embodiments contemplated herein include an apparatus having one or more processors and one or more computer-readable media, using or storing instructions that, when executed by the one or more processors, cause the one or more processors to perform one or more elements of the method 500, 600, or 700. In the context of method 500, or 600, this apparatus may be, for example, an apparatus of a UE (such as a wireless device 902 that is a UE, as described herein), or an apparatus of an access point or an application server (such as a network device 918 that is an access point or a base station, as described herein).

Embodiments contemplated herein include a signal as described in or related to one or more elements of the method 500, 600, or 700.

Embodiments contemplated herein include a computer program or computer program product having instructions, wherein execution of the program by a processor causes the processor to carry out one or more elements of method operations of FIGS. 5-7. In the context of FIGS. 5-7, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein); or the processor may be a processor of an access point, or a base station in a cellular carrier domain) (such as a processor(s) 922 of a network device 920 that is a base station, or an access point, as described herein), and the instructions may be, for example, located in the processor and/or on a memory of the base station or access point (such as a memory 924 of a network device 920 that is a base station, or an access point, as described herein).

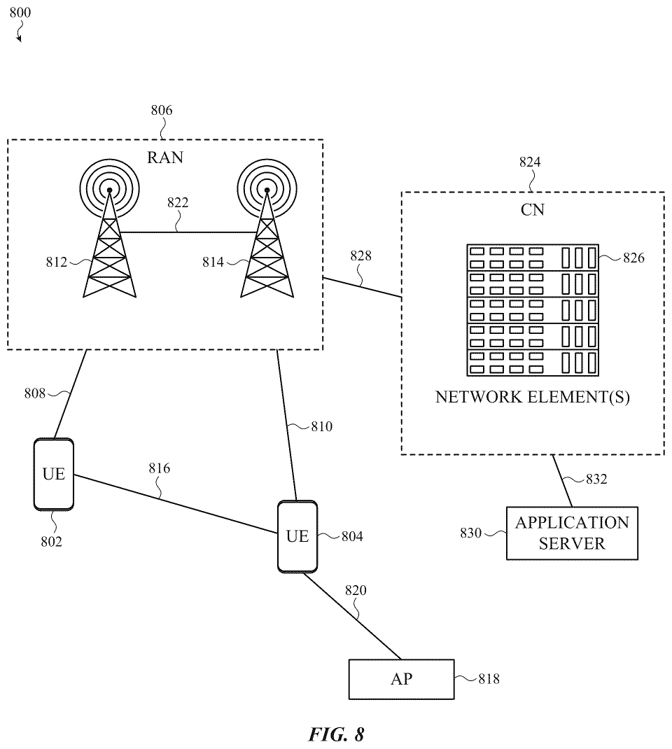

FIG. 8 depicts an example architecture of a wireless communication system of a cellular carrier domain, according to embodiments disclosed herein. The following description is provided for an example wireless communication system 800 that operates in conjunction with the LTE system standards and/or 5G or NR system standards, and/or future standards for 6G, and so on, as provided by 3GPP technical specifications.

As shown by FIG. 8, the wireless communication system 800 includes a UE 802 and a UE 804 (although any number of UEs may be used). In this example, the UE 802 and the UE 804 are illustrated as smartphones (e.g., handheld touchscreen mobile computing devices connectable to one or more cellular networks) but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling and may be consistent with one or more radio access technologies (RATs) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

FIG. 9 depicts a system for performing signaling between a UE and a network device, according to embodiments disclosed herein. System 900 may be a portion of a wireless communications system as herein described. The wireless device 902 may be, for example, a UE of a wireless communication system. The network device 920 may be, for example, a base station or an access point connected to a wireless communication system via wired or wireless communication links.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments, the wireless device 902 (e.g., a UE) may communicate with the network device 920 (e.g., a base station or an access point). The wireless device 902 may communicate with the access point via the antennas 912, and the access point may communicate with the network device 920 via a wired or wireless connection.

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a UE measurement module 916 configured to perform measurement of a duty cycle, P-MPR and L1-RSRP as described herein. The UE measurement module 916 may be implemented via hardware, software, or combinations thereof. For example, the UE measurement module 916 may be implemented as a processor, circuit, and/or instructions 908 stored in the memory 906 and executed by the processor(s) 904. In some examples, the UE measurement module 916 may be integrated within the processor(s) 904 and/or the transceiver(s) 910. For example, the UE measurement module 916 may be implemented by a combination of software components (e.g., executed by a DSP or a general processor) and hardware components (e.g., logic gates and circuitry) within the processor(s) 904 or the transceiver(s) 910.

The wireless device 902 may include one or more sensors, for example, a BPS 940. The body proximity sensor 940 may determine presence and/or absence of a human being and report an event. For example, based on an event reported by the BPS 940, the uplink duty cycle for one or more beams may be updated as described herein.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs. In certain embodiments, the signaling 938 may occur via a wired or a wireless network.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include a beam selection module 934 configured to select a beam based on one or more duty cycle reports, P-MPR reports, and one or more L1-RSRP reports received from the UE at the base station, as described herein. The beam selection module 934 may be implemented via hardware, software, or combinations thereof. For example, the beam selection module 934 may be implemented as a processor, circuit, and/or instructions 926 stored in the memory 924 and executed by the processor(s) 922. In some examples, the beam selection module 934 may be integrated within the processor(s) 922 and/or the transceiver(s) 928. For example, the beam selection module 934 may be implemented by a combination of software components (e.g., executed by a DSP or a general processor) and hardware components (e.g., logic gates and circuitry) within the processor(s) 922 or the transceiver(s) 928.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

What is claimed is:

1. A user equipment (UE), comprising:
a transceiver; and
a processor, configured to:
receive, from a base station and via the transceiver, a set of resource indicators identifying a set of beams and a configuration for reporting a duty cycle for transmission in an uplink direction, for at least one resource indicator of the set of resource indicators;
at least one of periodically or based on an event, determine the duty cycle for transmission in the uplink direction for the at least one resource indicator of the set of resource indicators; and
transmit, to the base station and via the transceiver, the determined duty cycle and a corresponding the at least one resource indicator of the set of resource indicators, according to the received configuration for reporting the duty cycle.

2. The UE of claim 1, wherein the event comprises an event reported by a body proximity sensor (BPS) that indicates absence of a human being within a predetermined threshold distance, and
wherein the processor is further configured to increase the duty cycle for the uplink transmission over one or more beams of the set of beams associated with the at least one resource indicator of the set of resource indicators.

3. The UE of claim 1, wherein the event comprises an event reported by a body proximity sensor (BPS) that indicates presence of a human being within a predetermined threshold distance, and
wherein the processor is further configured to decrease the duty cycle for the uplink transmission over one or more beams of the set of beams associated with the at least one resource indicator of the set of resource indicators.

4. The UE of claim 1, wherein, to determine the duty cycle for the uplink transmission, the processor is further configured to:
determine a maximum power emission criterion corresponding to an event reported by a body proximity sensor (BPS); and
determine the duty cycle for the at least one resource indicator based on a power management maximum power reduction (P-MPR) associated with the at least one resource indicator, the determined duty cycle for the at least one resource indicator and a corresponding P-MPR for the at least one resource indicator satisfying the determined maximum power emission criterion.

5. The UE of claim 1, wherein the event comprises: change in an uplink duty cycle that exceeds a specific threshold, change in an uplink duty cycle value for a specific number of beams, change in an uplink duty cycle value that occurs for a beam being used for data transmission in the uplink or a downlink direction, and
wherein the processor is further configured to transmit in a medium access control layer control element (MAC CE), or in uplink control information in a physical uplink control channel (PUCCH) or a physical uplink shared channel (PUSCH) message, to the base station and via the transceiver, the determined duty cycle and the corresponding the at least one resource indicator.

6. The UE of claim 1, wherein the processor is further configured to determine the duty cycle for one of: a next prohibit timer period, a time period configured using a radio resource control configuration (RRCConfiguration) message, or periodically.

7. The UE of claim 1, wherein the processor is further configured to determine the duty cycle for a first portion of a time window of maximum power emission (MPE) based on the uplink transmission during a second portion of the time window of the MPE, the second portion of the time window of the MPE preceding the first portion of the time window of the MPE.

8. The UE of claim 1, wherein the processor is further configured to:
determine a first beam and a second beam of the set of beams are not overlapping with each other; and
determine the duty cycle for a resource indicator of the set of resource indicators associated with the first beam and the duty cycle for a resource indicator of the set of resource indicators associated with the second beam.

9. The UE of claim 8, wherein the processor is further configured to transmit, to the base station and via the transceiver, a report including the determined duty cycle for the resource indicator associated with the first beam and the determined duty cycle for the resource indicator associated with the second beam.

10. The UE of claim 8, wherein the processor is further configured to transmit, to the base station and via the transceiver, a first report including the determined duty cycle for the resource indicator associated with the first beam, and a second report including the determined duty cycle for the resource indicator associated with the second beam.

11. The UE of claim 8, wherein the processor is further configured to transmit, to the base station and via the transceiver, a report including an average of the determined duty cycle for the resource indicator associated with the first beam and the determined duty cycle for the resource indicator associated with the second beam.

12. The UE of claim 8, wherein the processor is further configured to:
determine a first beam and a second beam of the set of beams belong to different beam groups; and
in response to determining the first beam and the second beam belong to the different beam groups, transmit, to the base station and via the transceiver, a first report including the determined duty cycle for the resource indicator associated with the first beam, and a second report including the determined duty cycle for the resource indicator associated with the second beam.

13. A base station comprising:
a transceiver; and
a processor, configured to:
transmit, to a user equipment (UE) and via the transceiver, a set of resource indicators identifying a set of beams and a configuration for reporting a duty cycle for transmission in an uplink direction, for at least one resource indicator of the set of resource indicators; and
according to the configuration for reporting the duty cycle, receive, from the UE and via the transceiver, the duty cycle for transmission in the uplink direction and a corresponding resource indicator of the set of resource indicators, the duty cycle received from the UE on a periodic basis or in response to an event reported by a body proximity sensor (BPS) of the UE.

14. The base station of claim 13, wherein the processor is further configured to transmit to the UE the configuration for reporting the duty cycle by calculating the duty cycle for a first portion of a time window of maximum power emission (MPE) based on the transmission in the uplink direction during a second portion of the time window of the MPE, the second portion of the time window of the MPE preceding the first portion of the time window of the MPE.

15. The base station of claim 13, wherein the processor is further configured to transmit to the UE the configuration for reporting the duty cycle by calculating the duty cycle for a next prohibit timer, the next prohibit timer corresponding to a period during which reporting of the duty cycle is prohibited.

16. A method, comprising:
receiving, at a user equipment (UE) and from a base station, a set of resource indicators identifying a set of beams and a configuration for reporting a duty cycle for transmission in an uplink direction, for one or more resource indicators of the set of resource indicators;
at least one of periodically or based on an event, determining, by the UE, the duty cycle for transmission in the uplink direction for the one more resource indicators of the set of resource indicators; and
transmitting, from the UE to the base station, the determined duty cycle and a corresponding one or more resource indicators of the set of resource indicators, according to the received configuration for reporting the duty cycle.

17. The method of claim 16, wherein the event comprises an event reported by a body proximity sensor (BPS) that indicates absence of a human being within a predetermined threshold distance, and
wherein the method further comprises increasing, by the UE, the duty cycle for transmission in the uplink direction over one or more beams of the set of beams associated with for the one or more resource indicators.

18. The method of claim 16, wherein the event comprises an event reported by a body proximity sensor (BPS) that indicates presence of a human being within a predetermined threshold distance, and
wherein the method further comprises decreasing, by the UE, the duty cycle for transmission in the uplink direction over one or more beams of the set of beams associated with for the one or more resource indicators.

19. The method of claim 16, wherein determining the duty cycle for transmission in the uplink direction comprises:
determining, by the UE, a maximum power emission requirement corresponding to the event reported by a body proximity sensor (BPS); and
determining, by the UE, the duty cycle for the one or more resource indicators based on a power management maximum power reduction (P-MPR) associated with the one or more resource indicators, the determined duty cycle for the one or more resource indicators and a corresponding P-MPR for the one or more resource indicators satisfying the determined maximum power emission requirement.

20. The method of claim 16, wherein the event comprises: change in an uplink duty cycle that exceeds a specific threshold, change in an uplink duty cycle value for a specific number of beams, change in an uplink duty cycle value that occurs for a beam being used for data transmission in the uplink or a downlink direction, and
wherein the method further comprises transmitting in a medium access control layer control element (MAC CE), or in uplink control information in a physical uplink control channel (PUCCH) or a physical uplink shared channel (PUSCH) message, from the UE to the base station, the determined duty cycle and the corresponding one or more resource indicators.
